(19) United States
(12) Patent Application Publication
(10) Pub. No.: US 2003/0124336 A1
(43) Pub. Date: Jul. 3, 2003

(54) Adhesive system for absorbent structures

(76) Inventors: James M. Keane, Conway, AR (US); Andrew M. Lake, Manitowoc, WI (US); Steven J. Nielsen, Conway, AR (US); Shelley R. Rasmussen, Oshkosh, WI (US)

Correspondence Address: KIMBERLY-CLARK WORLDWIDE, INC., 401 NORTH LAKE STREET, NEENAH, WI, 54956

(21) Appl. No.: 10/306,549

(22) Filed: Nov. 26, 2002

Related U.S. Application Data
(60) Provisional application No. 60/336,097, filed on Nov. 30, 2001.

(51) Int. Cl. B32B 5/14; B32B 3/26; B32B 7/12

(52) U.S. Cl. 428/317.1; 428/304.4; 428/309.9

(57) ABSTRACT

An absorbent structure that includes: (1) a liquid permeable cover having a first surface area; (2) at least one layer of at least one liquid management material having a second surface area that is less than the first surface area; and (3) an adhesive system joining the liquid permeable cover and the liquid management material. The continuous layer of adhesive overlaying the permeable cover material desirably has a basis weight of 7.5 gsm or less. For example, layer of adhesive may have a basis weight of 4 gsm or 1.0 gsm or less .The absorbent structure may be mechanically post-treated. For example, the absorbent structure may be introduced into a nip and/or subjected to mechanical post treatments such as, for example, embossing, perforating, brushing, creping, aperturing and the like. A method of making an absorbent structure that may include the following steps: (1) providing a liquid permeable nonwoven cover composed of a matrix of fibrous material and having a plurality of individual exposed fiber surfaces; (2) applying a thin, substantially continuous layer of adhesive material coating to at least a portion of the individual exposed fiber surfaces of individual fiber surfaces; (3) providing at least one layer of at least one liquid management material; and (4) joining the liquid permeable cover and the liquid management material. A non-contact adhesive system for joining dissimilar material components in which an adhesive is applied at a rate of less than 7.5 gsm utilizing a non-contact applicator in several generally parallel, substantially or totally non-intersecting lines after the cover and discrete liquid management material (distribution layer) are joined and exit a post treatment step such as, for example, an aperturing module. The adhesive could also be applied in several wavy lines, sinusoidal lines, parallel lines and other similar non-intersecting adhesive configurations.

This application claims priority from U.S. Provisional Application No. 60/336,097 filed Nov. 31, 2001.

### BACKGROUND OF THE INVENTION

The present invention relates to an adhesive system for absorbent structures.

Generally speaking, conventional absorbent personal care products contain an adhesive of some type to hold components or structures together during production and use. Many of these conventional products include one or more absorbent composite laminate materials. These absorbent composite laminate materials typically use adhesive, thermal and/or mechanical bonding to join layers of the absorbent composite laminate together and/or join the absorbent composite laminate to other components.

For example, at least one commercial product utilizes a pin stripe pattern of adhesive across the full width of the product to join a liquid permeable cover and absorbent materials immediately below the cover. Such an application of adhesive can generate many problems when mechanically post-treating (i.e., manipulating) the absorbent structure. These problems may be particularly evident when the assembly passes between a nip created by two or more rolls. While use of adhesives to join elements may be described in the literature, it appears that little, if any, references address the interaction between adhesives and subsequent mechanical post-treatment or manipulating steps.

For example, U.S. Pat. No. 5,411,497, U.S. Pat. No. 5,425,725, U.S. Pat. No. 5,433,715, and U.S. Pat. No. 5,593,399, assigned to Kimberly-Clark Corporation, discuss the use of a water sensitive adhesive for the formation of pockets between two carrier layers containing superabsorbent particles. The adhesive pattern can be a uniform continuous layer, patterned layer, swirls, spots, etc. According to at least some of these references, adhesive may be applied to one or both carrier sheets with an add-on amount greater than 7.5 grams per square meter and less than 150 grams per square meter.

U.S. Pat. No. 4,573,986, assigned to The Procter & Gamble Company, teaches the use of a pattern or network of open filaments or fibers between a liquid permeable cover and an absorbent element at an add-on level ranging from 0.8 to 4.7 grams per square meter. According to this patent, an open pattern or network of adhesive is used to join an absorbent core of relatively unbonded fibers to a permeable cover.

U.S. Pat. No. 4,069,822 and U.S. Pat. No. 4,147,580, assigned to The Procter & Gamble Company, teach a porous web that is overall or pattern coated with an extremely low level of hot-melt adhesive by causing the hot-melt adhesive to be wiped from an adhesive source by the individual projecting surface fibers and fiber junctions of the web to form globules on the individual projecting surfaces.

U.S. Pat. No. 5,560,974, assigned to Kappler Safety Group, discusses the use of a non-continuous application of adhesive to avoid interfering with the functionality of microporous films or film and nonwoven laminates.

U.S. Pat. No. 5,843,057, assigned to Kimberly Clark Worldwide, Inc., teaches a pattern of adhesive for use in laminating a film and nonwoven material. The add-on detailed in between 0.1 and 20 grams per square meter.

U.S. Pat. No. 6,063,981, assigned to Kimberly Clark Worldwide, Inc., discusses an adhesive used to prepare absorbent products without visible adhesive staining. This appears to relate to a breathable microporous film materials. The amount of adhesive may be, for example, between 0.5 and 10 grams per square meter of applied surface area.

U.S. Pat. No. 6,231,555, assigned to The Proctor and Gamble Company, teaches an adhesive of unspecified add-on level or rate, which is used to hold together layers of an absorbent article. This is done with a continuous pattern layer of meltblown fibers, separate lines, spirals, spots or the like.

Finally, U.S. Pat. No. H0,001,989, assigned to Kimberly-Clark Worldwide, Inc., discusses using adhesive on a microporous film to create regions of zoned breathability. The adhesive levels mentioned range from 1 to 7 grams per square meter. This document appears to describe the need to use an appropriate level of adhesive to obtain the desired breathability level in a product.

### SUMMARY OF THE INVENTION

The present invention relates to a non-contact adhesive system for joining dissimilar material components. More particularly, after the permeable cover and liquid management material are joined (and in some cases post-treated by techniques such as, for example, aperturing), that assembly is joined to the other components of the personal care product such as a baffle, absorbent core or the like.

According to an embodiment of the present invention, an adhesive is applied at a rate of less than 7.5 gsm utilizing a non-contact applicator in several generally parallel, substantially or totally non-intersecting lines after the cover and discrete liquid management material (distribution layer) are joined and exit a post treatment step such as, for example, an aperturing module. The adhesive may also be applied in several wavy lines, sinusoidal lines, parallel lines and other similar non-intersecting adhesive configurations.

This aspect of the invention provides for the joining and mechanical manipulation or treatment of a liquid permeable cover and adjacent layers (e.g., liquid management material layers) and then the subsequent joining or bonding of that treated assembly with adhesive to the other components that form a personal care product while providing the necessary product integrity in the form of adhesive side and end seals while avoiding exposed adhesive as in conventional processes described below.

According to an aspect of the invention, if the line spacing of a generally straight, wavy or sinusoidal non-intersecting line adhesive application pattern is adequate for attaching the substrates in question and the grams of add-on per pad are identical with the swirl or meltblown non-contact systems, then the individual bead of the generally straight, wavy or sinusoidal non-intersecting pattern would have more mass. This is generally thought to improve adhesive penetration into (but not through) the liquid permeable cover material. This additional bulk (mass) or actual weight of adhesive in the actual adhesive contact area will enhance the flow or vertical movement of adhesive within the components (particularly within the liquid permeable cover) thereby improving attachment strengths between the substrates.

Definitions

“Disposable” includes being disposed of after use and not intended to be washed and reused.

“Layer” when used in the singular can have the dual meaning of a single element or a plurality of elements.

“Liquid” means a non-particulate substance and/or material that flows and can assume the interior shape of a container into which it is poured or placed.

“Liquid communication” means that liquid is able to travel from one layer to another layer, or one location to another within a layer.

“Longitudinal” means having the longitudinal axis in the plane of the article and is generally parallel to a vertical plane that bisects a standing wearer into left and right body halves when the article is worn. The “transverse” axis lies in the plane of the article generally perpendicular to the longitudinal axis, i.e., so that a vertical plane bisects a standing wearer into front and back body halves when the article is worn.

“Conjugate fibers” refers to fibers that have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. The fibers may also have shapes such as those described in U.S. Pat. Nos. 5,277,976 to Hogle et al., and 5,069,970 and 5,057,368 to Largman et al., hereby incorporated by reference in their entirety, which describe fibers with unconventional shapes.

“Biconstituent fibers” refers to fibers that have been formed from at least two polymers extruded from the same extruder as a blend. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. No. 5,108,827 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein, the term “machine direction” or MD means the length of a fabric in the direction in which it is produced. The term “cross machine direction” or CD means the width of fabric, i.e. a direction generally perpendicular to the MD.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 35 microns. The fibers may also have shapes such as those described in U.S. Pat. No. 5,277,976 to Hogle et al., U.S. Pat. No. 5,466,410 to Hills and 5,069,970 and 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers that may be continuous or discontinuous, are generally smaller than 10 microns in average diameter, and are generally tacky when deposited onto a collecting surface.

As used herein, “Airlaying” refers to a well-known process by which a fibrous nonwoven layer can be formed. In the airlaying process, bundles of small fibers having typical lengths ranging from about 3 to about 52 millimeters are separated and entrained in an air supply and then deposited onto a forming screen, usually with the assistance of a vacuum supply. The randomly deposited fibers then are bonded to one another using, for example, hot air or a spray adhesive. Examples of airlaying technology can be found in U.S. Pat. Nos. 4,494,278, 5,527,171, 3,375,448 and 4,640,810.

As used herein, the term “coform” means a process in which at least one meltblown diehead is arranged near a chute through which other materials are added to the web while it is forming. Such other materials may be pulp, superabsorbent or other particles, natural polymers (for example, rayon or cotton fibers) and/or synthetic polymers (for example, polypropylene or polyester) fibers, for example, where the fibers may be of staple length. Coform processes are shown in commonly assigned U.S. Pat. Nos. 4,818,464 to Lau and 4,100,324 to Anderson et al. Webs produced by the coform process are generally referred to as coform materials.

“Bonded carded web” refers to webs that are made from staple fibers that are sent through a combing or carding unit, which opens and aligns the staple fibers in the machine direction to form a generally machine direction-oriented fibrous nonwoven web. The web is bonded by one or more of several known bonding methods.

Bonding of nonwoven webs may be achieved by a number of methods; powder bonding, wherein a powdered adhesive is distributed through the web and then activated, usually by heating the web and adhesive with hot air; pattern bonding, wherein heated calender rolls or ultrasonic bonding equipment are used to bond the fibers together, usually in a localized bond pattern, though the web can be bonded across its entire surface if so desired; through-air bonding, wherein air which is sufficiently hot to soften at least one component of the web is directed through the web; chemical bonding using, for example, latex adhesives that are deposited onto the web by, for example, spraying; and consolidation by mechanical methods such as needling and hydroentanglement.

An intake/distribution layer is a material which can wick menstrual fluid a distance of 1.2 cm to about 15.25 cm (0.5 to 6 inches) in one hour when one end of the material is placed in an infinite reservoir of menstrual simulant.

“Co-aperture” refers to a material which has been apertured, as well as a process of aperturing, wherein two or more materials are apertured together. The apertures extend from top to bottom of the material and are essentially aligned with each other. Co-aperturing can join the materials either temporarily or permanently through entanglement, physical bonding or chemical bonding. It is preferred that co-aperturing be carried out at ambient temperatures, not at elevated temperatures.

“Personal care product” means diapers, training pants, absorbent underpants, adult incontinence products, swim wear, bandages and other wound dressings, and feminine hygiene products.

“Feminine hygiene products” means sanitary napkins and pads. “Target area” refers to the area or position on a personal care product where an insult is normally delivered by a wearer.

Test Methods

Material Caliper (Thickness)

The caliper of a material is a measure of thickness and is measured at 0.05 psi (3.5 g/cm²) with a Starret-type bulk tester, in units of millimeters.

Density

The density of the materials is calculated by dividing the weight per unit area of a sample in grams per square meter (gsm) by the material caliper in millimeters (mm) at 0.05 psi (3.5 g/cm²) and multiplying the result by 0.001 to convert the value to grams per cubic centimeter (g/cc). A total of three samples would be evaluated and averaged for the density values.

Triple Intake Test Procedure

The objective of this test is to determine differences between materials and/or materials, composites or systems of material composites in the rate of intake when 3 fluid insults are applied, with time allowed for fluid to distribute in the material(s) between insults.

Equipment Needed

2 acrylic rate blocks.

P-5000 pipette with RC-5000 tips and foam pipette insert.

Small beaker

Menses simulant (made according to directions below), warmed in bath for 30 minutes or more

Small spatula (stirrer)

Bench liner

2 stopwatches

1-2 timers

Gauze squares for cleaning simulant

Procedure: Lay out sample composites according to materials testing plan.

Components are as follows

Top: Cover

Middle: Capillarity fabric

Bottom: Retention Layer

Weigh each layer dry, record weight. Put materials back in 3-layer composite.

Weigh a dry blotter, record weight and also mark weight on blotter.

Place acrylic rate block in middle of sample composite.

Calibrate pipette:

Weigh a small empty beaker on the balance.

Set pipette to 2 mls.

Draw simulant into pipette.

Deliver simulant from pipette into beaker.

If balance indicates 2 grams of simulant was delivered, setting is correct.

If more or less than 2 grams was delivered, decrease or increase the setting and repeat adjusting pipette and weighing the amount of stimulant delivered until 2 grams is delivered.

Simulant Handling

Remove simulant from the refrigerator 30 minutes to 1 hour before using and warm in water bath. Before cutting bag nozzle, massage the bag between hands for a few minutes to mix the simulant, which will have separated in the bag. Cut the bag tubing and pour simulant needed into a small beaker. Stir slowly with a small spatula to mix thoroughly. Return bag to the refrigerator if you do not anticipate using all of it. Return bag to water bath if more will be used during the day.

Test

Step 1: Center acrylic rate block with funnel on sample. Insult sample composite with 2 mls. simulant, using stopwatch to measure the time from the start of the insult until the fluid is absorbed beneath the cover material. Leave rate block in place for 9 minutes, (use timer). For first sample, after 9 minutes remove the rate block and weigh each layer of the sample. Record the weight. (After 3 minutes timing of the first sample, start testing a second sample going through the same steps.)

Step 2: For the first sample, repeat Step 1 a second time.

Step 3: For the first sample, repeat Step 1 a third time.

Analysis: The fluid loading in each component is calculated as weight after insult subtracted from the weight before insult. The insult time is a direct measurement of time for absorption. Smaller values of intake time refer to a more absorbent sample with larger values of intake time refer to a less absorbent sample.

Capacity

Capacity was measured using the dunk and drip capacity test method. Menses simulant was used as the test fluid. The sample size was modified to a 5.7 cm (2.25″) diameter circle. The weight of each sample was recorded. The sample was immersed in a bath of simulant until equilibration, in this case 9 minutes. The sample was removed from the bath and hung vertically at a height of 10.5 cm (12 inches) using a small clip for 10 minutes. The sample was weighed and the weight was recorded. The capacity was determined by subtracting the before weight from the after weight. The capacity in grams/gram was determined by dividing the capacity in grams by the dry weight of the sample.

Horizontal Capillary Wicking Test Procedure

The objective of this test it to determine the horizontal wicking capability of a material as it pulls fluid from a infinite reservoir.

Equipment needed: Horizontal wicking stand, menses simulant prepared as described below, ruler, timer.

Procedure

Cut materials to 1″ (2.54 cm) width and desired length.

Fill reservoir in horizontal wicking apparatus with menses simulant.

Place one end of the material in the simulant and lay the rest of the material on the wicking apparatus.

Start the timer.

Measure the distance wicked at a given time, or the time to wick to a given distance.

Flat System Testing Procedure

The purpose of this procedure is to determine the fluid handling characteristics of various absorbent systems through analysis of stain length, saturation capacity, and the fluid loading of the system components. The equipment required includes hourglass-shaped acrylic plates (with a 0.25 inch hole in the center) weighing approximately 330 grams, syringes, one-eighth inch I.D. Tygon tubing, pipette pump, menses simulant, and a laboratory balance (accurate to 0.00 g).

Samples to be tested are cut to a desired shape (currently 1.5 inches by 5.5 inches for fluid intake/distribution layers or capillarity fabrics, 1.75 inches by 5.5 inches for transfer delay layers, and 200 mm long hourglass shape for retention layers). The 5.5 inch layers are marked into 1.1 inch sections and the pad layer is marked into sections corresponding to the marks on the 5.5 inch layers when they are centered on the pad layer. Each component is weighed and the weight recorded. The individual components are assembled into a desired component system maintaining the marked sections aligned and one end is labeled as the top. Syringes are filled with menses simulant and Tygon tubing attached to the syringes. The syringes are placed in a pipette pump which is programmed to deliver a given amount of simulant, currently 30 cc syringes dispensing a specified amount of simulant (usually 10 ml) in one hour. With the open ends of the tubing placed in a beaker, the tubing is primed by running the pump until all air is out of the tubing and simulant is exiting the tubing at the insult end. The component systems to be tested are placed near the pipette pump and a two inch by six inch piece of 25 gsm, 10d BCW is placed on top of the center of the system over which an acrylic plate is placed, also centered on top of the system. The free end of one tubing is inserted into the hole in the acrylic plate and the pipette pump started to begin the insults. At the end of the insult period, the tubing and acrylic plates are removed. The BCW is then carefully removed without moving the underlying layers and discarded. Each layer is then individually weighed and the weight recorded. Then, beginning at the end labeled as the top, each marked section is cut and weighed. The stain length for each layer is measured and recorded and the data entered into a spreadsheet for graphing and analysis. The fluid loading (g/g) is calculated by dividing the amount of fluid absorbed in a material by the dry weight of the material. The fluid saturation is calculated by dividing the fluid loading by the stain length.

Demand Absorbency Wicking Capability

The objective of this test is to determine the fluid handling characteristics of various absorbent systems through analysis of stain length, saturation capacity, and fluid loadings of the system components.

Equipment needed: Hourglass-shaped acrylic plates (with 0.25″ (6.35 mm) hole in the center) weighing approximately 330 grams; syringes; ⅛ inch (3.175 mm) internal diameter (ID) tubing (e.g. Tygon®); pipette pump; menses simulant prepared as described below; laboratory balance (accurate to 0.00 g).

Procedure

1. Cut components to desired shape; 1.5 inches (3.8 cm) by 6.0 inches (15.2 cm) for intake/distribution layers, 3.0 inches (7.6 cm) by 6.0 inches for spunbond nonwoven fabric transfer delay and perimeter layers.

2. Mark 6.0 inch layers into 1.2 inch (3 cm) sections. If the perimeter layer is oval, mark into sections corresponding to the marks on the intake/distribution strip when centered on the perimeter layer.

3. Weigh each component and record the weight.

4. Assemble the individual components into the desired absorbent system keeping the marked sections aligned. Label one end as the top.

5. Fill the syringes with menses simulant and attach tubing to syringes.

6. Place the syringes in the syringe pump.

7. Program the size of the syringe into the syringe pump.

8. Program the pump (currently using 30 cc syringes dispensing at a rate of 10 ml. per hour.

9. With the open ends of the tubing placed in a beaker, prime tubing by running pump until all air is out of tubing and simulant is exiting the tubing at the open end.

10. Place the component systems to be tested near the syringe pump, place a 2 inch (5.1 cm) by 6 inch (approximately) piece of 25 gsm, 10 denier bonded carded web material on the top layer of the absorbent system to prevent wicking on the acrylic plate, and place an acrylic plate centered on the top of the system.

11. Insert the open end of one tubing into the hole in the acrylic plate. Repeat for the remaining systems to be tested.

Testing

1. Start the pipette pump to begin the insult.

2. Ad 3 mls. of menses simulant at a rate of 10 mls per hour.

3. After 3 mls have been insulted into the product, add weights to the acrylic plate to achieve a pressure of 0.08 psi.

4. Continue the insults for another 5 mls, so that a TOTAL of 8 mls is insulted.

5. At the end of the insult period, remove the tubing and acrylic plates. Carefully remove the bonded carded web without moving the underlying layers and discard it.

6. Take photos of the component system and layers and print them.

7. Weigh each layer individually and record the weight.

8. Beginning at the end labeled as the top, cut and weigh the first marked sections and the weight. Repeat for remaining sections and layers.

9. Measure and record the stain length for each layer.

10. Enter the data in a spreadsheet for graphing and analysis.

Preparation of Menses Simulant

The artificial menses liquid used in the testing was made according to U.S. Pat. No. 5,883,231 from blood and egg white by separating the blood into plasma and red cells and separating the white into thick and thin portions, where “thick” means it has a viscosity after homogenization above about 20 centipoise at 150 sec⁻¹, combining the thick egg white with the plasma and thoroughly mixing, and finally adding the red cells and again thoroughly mixing. A more detailed procedure Follows:

Defibrinated swine blood, is separated by centrifuging at 3000 rpm for 30 minutes, though other methods or speeds and times may be used if effective. The plasma is separated and stored separately, the buffy coat removed and discarded and the packed red blood cells stored separately as well. It should be noted that the blood must be treated in some manner so that it may be processed without coagulating. Various methods are known to those skilled in the art, such as defibrinating the blood to remove the clotting fibrous materials, the addition or anti-coagulant chemicals and others. The blood must be non-coagulating in order to be useful and any method which accomplishes this without damaging the plasma and red cells is acceptable.

Jumbo chicken eggs are separated, the yolk and chalazae discarded and the egg white retained. The egg white is separated into thick and thin portions by straining the white through a 1000 micron nylon mesh for about 3 minutes, and the thinner portion discarded. The thick portion of egg white, which is retained on the mesh, is collected and drawn into a 60 cc (cm³) syringe, which is then placed on a programmable syringe pump and homogenized by expelling and refilling the contents five times. The amount of homogenization is controlled by the syringe pump rate of about 100 mL /min, and the tubing inside diameter of about 0.12 inches. After homogenizing the thick egg white has a viscosity of about 20 centipoise at 150 sec¹ and is then placed in the centrifuge and spun to remove debris and air bubbles at about 3000 rpm for about 10 minutes.

After centrifuging, the thick, homogenized egg white, which contains ovamucin, is added to a 300 cc FENWAL® Transfer pack container using a syringe. Then 60 cc of the swine plasma is added to the FENWAL® Transfer pack container. The FENWAL® Transfer pack container is clamped, all air bubbles removed, and placed in a Stomacher lab blender where it is blended at normal (or medium) speed for about 2 minutes. The FENWAL® transfer pack container is then removed from the blender, 60 cc of swine red blood cells are added, and the contents mixed by hand kneading for about 2 minutes or until the contents appeared homogenous. A hematocrit of the final mixture should show a red blood cell content of about 30 weight percent and generally should be at least within a range of 28-32 weight percent for artificial menses made according to this Example. The amount of egg white is about 40 weight percent.

The ingredients and equipment used in the preparation of artificial menses are readily available. Below is a listing of sources for the items used, though of course other sources may be used providing they are approximately equivalent.

Blood (swine): Cocalico Biologicals, Inc., 449 Stevens Rd., Reamstown, Pa. 17567, (717) 336-1990.

Fenwal® Transfer pack container, 300 mL, with coupler, code 4R2014: Baxter Healthcare Corporation, Fenwal Division, Deerfield, Ill. 60015.

Harvard Apparatus Programmable Syringe Pump model no. 55-4143: Harvard Apparatus, South Natick, Mass. 01760.

Stomacher 400 laboratory blender model no. BA 7021, serial no. 31968: Seward Medical, London, England, UK.

1000 micron mesh, item no. CMN-1000-B: Small Parts, Inc., PO Box 4650, Miami Lakes, Fla. 33014-0650, 1-800-220-4242.

Hemata Stat-II device to measure hemocrits, serial no. 1194Z03127: Separation Technology, Inc., 1096 Rainer Drive, Altamont Springs, Fla. 32714.

Rate Block Intake Test

This test is used to determine the intake time of a known quantity of fluid into a material and/or material system. The test apparatus consists of a rate block 10 as shown in FIG. 1. A 4″×4″ piece of absorbent 14 and cover 13 are die cut. The specific covers are described in the specific examples. The absorbent used for these studies was standard and consisted of 250 g/m² airlaid made of 90% Coosa 0054 and 10% HC T-255 binder. The total density for this system was 0.10 g/cc. The cover 13 was placed over the absorbent 14 and the rate block 10 was placed on top of the two materials. 2 mL of a menses simulant was delivered into the test apparatus funnel 11 and a timer started. The fluid moved from the funnel 11 into a channel 12 where it was delivered to the material or material system. The timer was stopped when all the fluid was absorbed into the material or material system as observed from the chamber in the test apparatus. The intake time for a known quantity of known fluid was recorded for a given material or material system. This value is a measure of a material or material systems absorbency. Typically, five to ten repetitions were performed, and average intake time was determined.

Rewet Test

This test is used to determine the amount of fluid that will come back to the surface when a load is applied. The amount of fluid that comes back through the surface is called the “rewet” value. The more fluid that comes to the surface, the larger the “rewet” value. Lower rewet values are associated with a dryer material and, thus, a dryer product. In considering rewet, three properties are important: (1) intake, if the material/system does not have good intake then fluid can rewet, (2) ability of absorbent to hold fluid (the more the absorbent holds on to the fluid, the less is available for rewet), and (3) flowback, the more the cover prohibits fluid from coming back through the cover, the lower the rewet. In our case, we evaluated cover systems where the absorbent was maintained constant and, thus, we were only concerned with properties (1) and (3), intake and flowback, respectively.

A 4″×4″ piece of absorbent and cover was die cut. The absorbent used for these studies was standard and consisted of a 250 g/m² airlaid made of 90% Coosa 0054 and 10% HC T-255 binder. The total density for this system was 0.10 g/cc. The cover was placed over the absorbent and the rate block was placed on top of the two materials. In this test, 2 mL of menses simulant are insulted into the rate block apparatus and are allowed to absorb into a 4″×4″ sample of the cover material which is placed on top of a 4″×4″ absorbent piece. The fluid is allowed to interact with the system for one minute and the rate block rests on top of the materials. The material system cover and absorbent are placed onto a bag filled with fluid. A piece of blotter paper is weighed and placed on top of the material system. The bag is traversed vertically until it comes into contact with an acrylic plate above it, thus pressing the whole material system against the plate blotter paper side first. The system is pressed against the acrylic plate until a total pressure of 1 psi is applied. The pressure is held fixed for three minutes, after which the pressure is removed and the blotter paper is weighed. The blotter paper retains any fluid that was transferred to it from the cover/absorbent system. The difference in weight between the original blotter and the blotter after the experiment is known as the “rewet” value. Typically, five to ten repetitions of this test were performed, and average rewet was determined.

Intake/Staining Test

An intake/staining test was developed which enables the stain size, intensity, and fluid retention in components to be observed with fluid flow rate and pressure. Menses simulant was used as the test fluid. A 4″×4″ piece of absorbent and cover were die cut. The absorbent used for these tests was standard and consisted of a 250 g/m² airlaid made of 90% of Coosa 0054 and 10% HC T-255 binder. The total density for this system was 0.10 g/cc. A material system, cover and core measuring 4″×4″, was placed underneath an acrylic plate with an ⅛ inch diameter hole bored into the center. A piece of ⅛ inch tubing was connected to the hole with a fitting. Menses simulant was delivered to the sample using a syringe pump at a specified rate and for a specified volume. The pump was programmed to deliver a total volume of 1 mL to the samples, where the samples were under pressures of 0 psi, 0.0078 psi, and 0.078 psi. These pressures were applied using a weight which was placed on top of the acrylic plates and distributed evenly. The flow rate of the pump was programmed to deliver fluid at a rate of 1 mL/sec. The stain size for the cover materials was measured manually, and the amount of fluid in each component of the system was measured by weight before and after absorption of the fluid. The stain intensity was evaluated qualitatively by comparison of samples. Staining information was recorded using a digital camera and could be further analyzed with image analysis.

Permeability

Permeability is obtained from a measurement of the resistance by the material to the flow of liquid. A liquid of known viscosity is forced through the material of a given thickness at a constant flow rate and the resistance to flow, measured as a pressure drop is monitored. Darcy's Law is used to determine permeability as follows:

Permeability=[flow rate×thickness×viscosity/pressure drop] Equation (1) where the units are:

| | |
|---|---|
| permeability: | cm² or darcy 1 darcy = 9.87 × 10⁻⁹ cm² |
| flow rate: | cm/sec |
| viscosity: | pascal-sec |
| pressure drop: | pascals |

The apparatus consists of an arrangement wherein a piston within a cylinder pushes liquid through the sample to be measured. The sample is clamped between two aluminum cylinders with the cylinders oriented vertically. Both cylinders have an outside diameter of 3.5″, an inside diameter of 2.5″ and a length of about 6″. The 3″ diameter web sample is held in place by its outer edges and hence is completely contained within the apparatus. The bottom cylinder has a piston that is capable of moving vertically within the cylinder at a constant velocity and is connected to a pressure transducer that capable of monitoring the pressure of encountered by a column of liquid supported by the piston. The transducer is positioned to travel with the piston such that there is no additional pressure measured until the liquid column contacts the sample and is pushed through it. At this point, the additional pressure measured is due to the resistance of the material to liquid flow through it.

The piston is moved by a slide assembly that is driven by a stepper motor. The test starts by moving the piston at a constant velocity until the liquid is pushed through the sample. The piston is then halted and the baseline pressure is noted. This corrects for sample buoyancy effects. The movement is then resumed for a time adequate to measure the new pressure. The difference between the two pressures is the pressure due to the resistance of the material to liquid flow and is the pressure drop used in Equation (1). The velocity of the piston is the flow rate. Any liquid whose viscosity is known can be used, although a liquid that wets the material is preferred since this ensures that saturated flow is achieved. The measurements disclosed herein were carried out using a piston velocity of 20 cm/min, mineral oil (Peneteck Technical Mineral Oil manufactured by Penreco of Los Angeles, Calif.) of a viscosity of 6 centipoise.

Alternatively, permeability can be calculated from the following equation:

Permeability=0.051*R*(1-Porosity)*(Porosity/(1-Porosity))^{2 75} Equation (2)

where R=fiber radius and

Porosity=1−(web density/fiber density) Equation (3)

Reference for Equation (2) can be found in the article “Quantification of Unidirectional Fiber Bed Permeability” by J. Westhuizen and J. P. Du Plessis in the Journal of Composite Materials, 28(7), 1994. Note that the equations show that permeability can be determined if fiber radius, web density and fiber density are known.

Conductance is calculated as permeability per unit thickness and gives measure of the openness of a particular structure and, thus, an indication of the relative ease at which a material will pass liquid. The units are darcies/mil.

### DETAILED DESCRIPTION

The present invention relates to a non-contact adhesive system for joining dissimilar material components. More particularly, after the permeable cover and liquid management material are joined (and in some cases post-treated by techniques such as, for example, aperturing), that assembly is bonded or attached to the other components of the personal care product such as a baffle, absorbent core or the like.

Most personal care products (e.g., sanitary napkins, pantiliners, etc.) contain an adhesive of some type to hold the components together during production and use. For example, some commercial products may contain a full width pin stripe adhesive pattern between a liquid permeable cover and a liquid management material (e.g., liquid distribution material, liquid absorbent materials and the like). As noted above, such a method of applying adhesive may generate problems when mechanically manipulating the cover and a discrete liquid management material in a post treatment step, particularly when the combination passes through a nip created by two rollers and more particularly, when the combination is apertured using techniques such as aperturing rolls.

When adhesive is applied in a more restricted manner as described above (on the area of the cover generally corresponding to the discrete liquid management material) and that assembly is joined with other components to produce a finished personal care product, the products did not maintain their integrity due to the missing adhesive between the cover and other components of the product.

This problem is addressed by an embodiment of the present invention in which an adhesive is applied at a rate of less than 7.5 gsm utilizing a non-contact applicator in several generally parallel, substantially or totally non-intersecting lines after the cover and discrete liquid management material (distribution layer) are joined and exit a post treatment step such as, for example, an aperturing module. The adhesive could also be applied in several wavy lines, sinusoidal lines, parallel lines and other similar non-intersecting adhesive configurations.

Such an embodiment provides for the joining and mechanical manipulation or treatment of a liquid permeable cover and adjacent layers (e.g., liquid management material layers) and then the subsequent joining or bonding of that treated assembly with adhesive to the other components that form a personal care product while providing the necessary product integrity in the form of adhesive side and end seals while avoiding exposed adhesive as in conventional processes described below.

Conventional pad construction processes may utilize a pin stripe adhesive pattern across the full width of the cover. Discrete components that are narrower than the cover may be put in position on the cover during the pad construction process. This leaves exposed portions of the adhesive on the cover. If the partially constructed assembly (e.g., cover material and discrete liquid management material) are mechanically manipulated or treated after their initial assembly (i.e., post-treated), the exposed portions of the adhesive may cause problems with operation of the equipment and continued construction of the pad.

For example, if a cover material/liquid management material assembly having exposed portions of adhesive is passed into a nip formed by rollers (such as a nip formed by aperturing rollers), the adhesive may build-up on the equipment, cause the assembly to stick, and/or have other undesirable consequences.

In the aperturing process, a continuous absorbent web is fed into a rotary die module where the absorbent distribution layer (DL) is radial end cut forming an oval shaped component. The 190 mm long, discrete piece is placed at product pitch on a continuous spunbond web that is traveling at machine velocity. For example, with a final pad length of 238 mm and a 190 mm×37 mm discrete piece centered on the pad, a gap of 48 mm exists between successive DL components. A thin film of hot melt adhesive is slot coated onto the spunbond (less than 7.5 gsm) with dimensions slightly smaller than that of the discrete piece. The DL component is joined to the spunbond and the assembly is apertured.

As mentioned above, the final product assembly requires that adhesive be applied on the sides and ends of the DL to attach the liquid permeable cover material (e.g., spunbond cover) to an absorbent core and a liquid impermeable back-sheet or baffle. Such an application of adhesive eliminates material separation between the cover and absorbent cores and prevents premature product failures, such as opening end or side seals and a blousing cover.

A conventional contact adhesive applicator requires the substrate to be adhesively treated to be pulled across the tip of the applicator to transfer adhesive to the substrate. In such a conventional operation, it is critical that the substrate maintain continuous contact with the applicator head as the substrate passes across the tip of the applicator to maintain a consistent add-on rate. Continuous contact between the tip and substrate also reduces the tendency for adhesive to pool at the application point, which can cause defective product, inconsistent add-on and machine delays resulting from down stream adhesive contamination.

However, in the assembly described above with the discrete liquid management material components placed at product pitch on a continuous web of liquid permeable cover material, it is important for the discrete components to avoid becoming separated from the continuous web as might happen when the discrete component encounters a contact applicator. Another disadvantage with a contact applicator is that the pressure/contact required for consistent application of adhesive also has a tendency to close or interfere with apertured that are produced on the cover material side of the assembly and open up onto the liquid management material side of the assembly.

According to the invention, the non-contact application of an adhesive such as a hot-melt adhesive should not interfere with the cover intake properties and should remain compatible with high speed manufacturing processes while using a minimum amount of adhesive (e.g., less than 2 gsm add-on). Several processes exist for applying adhesive with a non-contact system. These include adhesive swirl processes (continuous line forming a helical pattern, meltblowing processes (randomly laid fiber) and drool processes (non-overlapping bead).

In an aspect of this invention, the mass of adhesive in individual lines of the adhesive application pattern (i.e., the line mass) within a swirl, meltblown or drool application can be manipulated to minimize the amount of adhesive that is required to maintain sufficient attachment strengths between the liquid permeable cover and the polymer film backsheet or baffle.

Since an individual line or bead of a generally straight, wavy or sinusoidal non-intersecting line adhesive application pattern can be spaced at a desired frequency across the entire web, the overall mass (i.e., the sum of line mass) within that area can be controlled by line spacing. The actual covered area, where the bead resides, has a lower total surface area of adhesive than a swirl or meltblown pattern as expressed in terms of weight per unit area (e.g., grams per square meter) when the add-on measurement is based on the total web width.

If the line spacing of a generally straight, wavy or sinusoidal non-intersecting line adhesive application pattern is adequate for attaching the substrates in question and the grams of add-on per pad are identical with the swirl or meltblown non-contact systems, then the individual bead of the generally straight, wavy or sinusoidal non-intersecting pattern would have more mass. This is generally thought to improve adhesive penetration into (but not through) the liquid permeable cover material. This additional bulk (mass) or actual weight of adhesive in the actual adhesive contact area will enhance the flow or vertical movement of adhesive within the components (particularly within the liquid permeable cover) thereby improving attachment strengths between the substrates.

Variables that influence control of the non-overlapping or non-intersecting lines of adhesive are the viscosity of the adhesive, size of the individual orifice used to apply the adhesive, number of orifices across the deckle, and adhesive throughput. A positive displacement adhesive process uses back-pressure within the system to force the adhesive out the applicator head. Controlling the pressure to not exceed the design safety limits of hoses and seals etc. is important for safe performance. The orifice size and the number of orifices across the deckle will determine the amount of pressure built within the adhesive system when targeting a desired throughput. The line mass and individual adhesive line velocity at the orifice exit point at a given line speed will influence line control. The adhesive velocity at the exit point of the non-contact applicator (drool line) will desirably be held to an adhesive velocity to line speed ratio between 0.1 and 1.0, more desirably between about 0.2 to 0.8 and even more desirably between 0.3 to 0.6. If there is too little adhesive velocity, there will be areas that are not adequately coated on the substrate—negatively affecting bond strengths between the materials. Excessive levels of adhesive caused by too much adhesive velocity or too little line speed may increase costs and cause bleeding or seepage of adhesive from components.

Line pressure is connected to the adhesive exiting velocity. For systems used in the practice of the present invention, it is desirable that a line pressure between 200 and 700 psi is maintained. Pressures below these values will not generate sufficient exiting adhesive velocity, which causes poor line stability when using orifice sizes within the ranges described below.

Pressures above these values may cause angular deflection of the individual lines causing poor placement control. In order to meet a desirably 2 to 3 gsm target add-on rate using an exemplary hot melt construction adhesive (e.g., National Starch 34-5610 [Viscosity range 2000-5000 Mpas]), the orifice size needed to be within the range of 0.008″×0.008″ to 0.020″×0.020″. The smaller the orifice size, the greater the back pressure at the higher the exiting velocity. The number of orifices range from 4 to 8 across a 50 mm width in this exemplary execution.

In an embodiment of the invention, it is desirable to minimize the number of orifices across the 50 mm wide area. This makes it easier to maintain a line pressure above 200 psi, which is needed to obtain the low add-on desired. It takes a higher throughput when using more nozzles of the same dimension to keep the line pressure at a constant level. The smaller the actual line dimension at a given grams per pad add-on, the higher the line mass will be. As stated above, better penetration into the nonwoven is obtained at a higher line mass.

Line mass is indirectly connected to the ratio between the exiting velocity and the web velocity. As the differential increases (lower adhesive velocity versus web velocity), the thinner the line becomes as the adhesive is elongated in the Machine Direction (MD). Adhesive characteristics in a molten state will impact the response to the line pressure, exiting velocity, penetration into the nonwoven, and line mass. If the viscosity is low enough and there is sufficient line pressure to sustain the desired exiting velocity, there is the potential to have a higher degree of elongation. This elongation will determine the grams per pad and eventual line mass.

While this invention has been described as having a preferred embodiment, it will be understood that it is capable of further modifications. It is therefore intended to cover any variations, equivalents, uses, or adaptations of the invention following the general principles thereof, and including such departures from the present disclosure as come or may come within known or customary practice in the art to which this invention pertains and falls within the limits of the appended claims.

We claim:

1. A porous material laminate comprising:
at least a first and second layer of porous materials, each having an upper and lower surface;
an adhesive system joining at least a portion of the lower surface of the first layer of porous material to the upper surface of the second layer of porous material, the adhesive system comprising
at least one substantially continuous, thin bead of adhesive having a bead index less than and effective maximum level.

2. The porous material laminate of claim 1, having a peel strength not less than about an effective minimum level.

3. A personal care product incorporating the porous laminate of claim 1.

4. A method of producing a porous material laminate comprising the steps:
providing at least a first porous material with an upper and lower surface and a second porous material with an upper and lower surface;
applying at least one substantially continuous, thin bead of adhesive to at least one of either the lower surface of the first porous material or the upper surface of the second porous material where the bead of adhesive has a bead index less than an effective maximum level.
joining the first and second porous materials by contacting the lower surface of the first porous material and the upper surface of the second porous material.

5. A porous material laminate produced by the method of claim 4.

6. A personal care product incorporating the porous material laminate produced by claim 4.
